(19) United States
(12) Patent Application Publication
(10) Pub. No.: US 2010/0321442 A1
(43) Pub. Date: Dec. 23, 2010

(54) INKJET HEAD

(75) Inventors: Yoon-Sok Park, Suwon-si (KR); Jae-Woo Joung, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/636,354

(22) Filed: Dec. 11, 2009

(30) Foreign Application Priority Data
Jun. 17, 2009 (KR) 10-2009-0054065

(51) Int. Cl. B41J 2/14; B41J 2/045

(52) U.S. Cl. 347/47; 347/68

(57) ABSTRACT

An inkjet head is disclosed. In an embodiment of the present invention, the ink-jet head includes a chamber, which houses ink, and a nozzle, which ejects the ink housed in the chamber. Here, the nozzle is elliptical. The inkjet head can print a minute pattern and reduce its driving energy because the inkjet head can eject a smaller droplet of ink with less energy compared to the energy being applied for a conventional inkjet head.

### CROSS-REFERENCE TO RELATED APPLICATIONS

This application claims the benefit of Korean Patent Application No. 10-2009-0054065, filed with the Korean Intellectual Property Office on Jun. 17, 2009, the disclosure of which is incorporated herein by reference in its entirety.

### BACKGROUND

1. Technical Field

The present invention relates to an inkjet head.

2. Description of the Related Art

An inkjet printer is an apparatus for ejecting a droplet of ink through a nozzle by transforming an electric signal to a physical force. The inkjet head can be manufactured by forming different components, such as a chamber, a restrictor, a nozzle and a piezoelectric body, in several layers and stacking these layers on one another.

In recent years, the application of the inkjet head has expanded beyond the graphic printing industry to manufacturing printed circuit boards and electronic parts, such as LCD panels.

Accordingly, various functions that have not been required in the conventional fields of graphic printing are now required in current inkjet printing applications for manufacturing electronic components, in which it is critically important to eject the ink with high precision and accuracy. One of such functions is ejection of minute droplets of ink with enhanced stability.

Although there can be a variety of methods available for making a nozzle form, one of the most common methods is a silicon process using the microelectromechanical systems (MEMS) technology. Historically, a circular-shaped nozzle was used for the inkjet head. The currently available 1 pL-level print head with a circular nozzle requires a higher voltage for ejection of the ink droplet than ejection of the conventional droplet (for example, about 3 to 4 pL or greater in diameter). That is, greater energy is required. Accordingly, studies are needed for an inkjet head that can eject a smaller droplet with the same energy level used for ejecting the conventional droplet.

### SUMMARY

The present invention provides an inkjet head that can eject a smaller droplet of ink with less energy compared to the energy being applied for a conventional inkjet head.

An aspect of the present invention provides an ink-jet head that includes a chamber, which houses ink, and a nozzle, which ejects the ink housed in the chamber. Here, the nozzle is elliptical.

Another aspect of the present invention provides an ink-jet head that includes a chamber, which houses ink, and a nozzle, which ejects the ink housed in the chamber. Here, concavo-convex curves are successively formed on an inner surface of the nozzle.

The inkjet head can further include a piezoelectric body, which provides pressure to the chamber.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of an inkjet head in accordance with an embodiment of the present invention.

FIG. 2 shows a nozzle of an inkjet head in accordance with an embodiment of the present invention.

FIG. 3 shows a nozzle of another inkjet head in accordance with another embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed description of related art is omitted when it is deemed that it may unnecessarily obscure the essence of the invention.

An inkjet head according to certain embodiments of the present invention will be described below in more detail with reference to the accompanying drawings. Those components that are the same or are in correspondence are rendered the same reference numeral regardless of the figure number, and redundant descriptions are omitted.

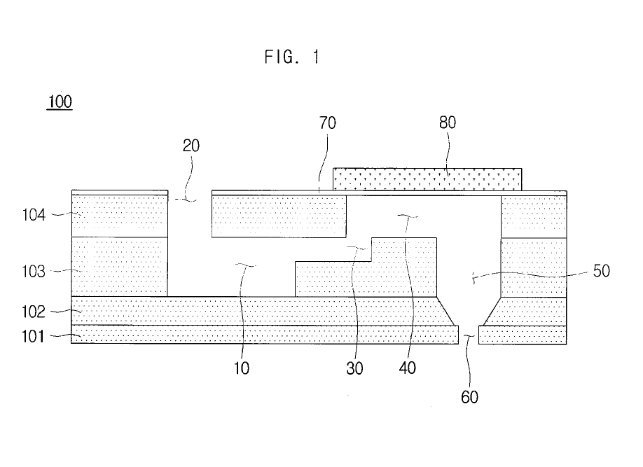

FIG. 1 is a cross-sectional view of an inkjet head according to an embodiment of the present invention. Illustrated in FIG. 1 are an inkjet head 100, a reservoir 10, an inlet 20, a restrictor 30, a chamber 40, a damper 50, nozzles 60 and 60b, a membrane 70 and a piezoelectric body 80.

The chamber 40, which contains ink, is a means for ejecting the ink by moving the contained ink in a direction of the nozzle 60 when pressure is applied by the piezoelectric body 80 and the like formed on an upper surface of the membrane 70. A plurality of chambers 40, for example, 128 chambers or 256 chambers, can be disposed in parallel in a single inkjet head, and there can be a matching number of piezoelectric bodies 80 to the chambers 40 in order to provide pressure to each of the plurality of chambers 40. Here, the piezoelectric bodies 80 are separated from one another so that adjacent chambers 40 are minimally influenced by the piezoelectric bodies 80.

The reservoir 10 is supplied with ink from the outside through the inlet 20, stores the ink, and provides the ink to the chamber 40 described above.

The restrictor 30 links the reservoir 10 with the chamber 40 and can function as a channel controlling the flow of ink between the reservoir 10 and the chamber 40. The restrictor 30 is formed to have a smaller sectional area than those of the reservoir 10 and the chamber 40 such that the restrictor 30 can control the amount of ink supplied to the chamber 40 from the reservoir 10 when the membrane 70 is vibrated by the piezoelectric body 80.

The nozzle 60 is connected to the chamber 40 and ejects the ink supplied from the chamber 40. When the vibration generated by the piezoelectric body 80 and the like is supplied to the chamber 40 through the membrane 70, pressure can be applied to the chamber 40, causing the nozzle 60 to eject the ink, which is transported from the chamber 40 to the nozzle 60.

The damper 50 is interposed between the chamber 40 and the nozzle 60. The damper 50 can converge the energy generated by the chamber 40 towards the nozzle 60 and dampen a rapid change in pressure.

Meanwhile, an upper electrode (not shown) and a lower electrode (not shown) can be formed on top and bottom of the piezoelectric body 80, respectively.

The inkjet head 100 having the above-described components can be formed either by stacking a plurality of substrates 101, 102, 103 and 104 made of for example, silicon or ceramic, as illustrated in FIG. 1, or with a single substrate.

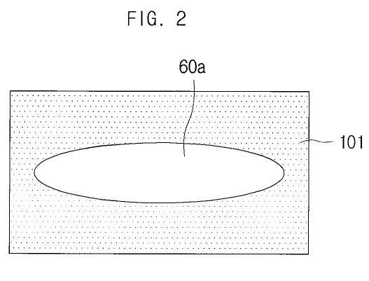

While the cross-sectional shape of the nozzle of a conventional inkjet head is usually circular, the inkjet head according to the present embodiment is equipped with the nozzle 60 that has an elliptical cross-section (refer to FIG. 2). The ink droplet being ejected through the nozzle 60 having an elliptical cross-section has a diameter that is similar to the diameter of a circle fitting in the inner perimeter of the elliptical shaped nozzle 60. This is because, at remaining portions excluding the circle fitting in the inner perimeter of the elliptical shaped nozzle 60, the adhesion between the ink and the inner wall of the nozzle 60 is stronger than the pressure applied by the piezoelectric body 80 for ejecting the ink. Therefore, in this embodiment, the ink can be transported smoothly from the chamber 40 to the nozzle 60 by providing a sufficient sectional area of the nozzle 60. At the same time, since the actual size of the ink droplet being ejected is close to the diameter of the circle fitting in the inner perimeter of the elliptical shaped nozzle 60, high resolution print can be obtained.

Meanwhile, the primary injection of ink into the inkjet head is referred to as “priming,” which is a process of injecting the ink into the inside of the inkjet head, which is initially occupied by air, by force. In addition, there is a similar process referred to as “purging” in using the inkjet head. Purging is a primary process of forcible removal of undesirable impurities, for example, air bubbles, from the inside of the inkjet head by forcing the ink inside the inkjet head towards the nozzle at intervals of using the inkjet head.

Both the priming and the purging are processes of forcing the ink towards the inside of the dense inkjet head by applying pressure, such as pneumatic pressure, to the package. In the case of an 1 pL-level inkjet head, the caliber of its nozzle is significantly smaller than those of bigger inkjet heads so that the efficiency of priming and purging is lower.

On the other hand, the elliptical nozzle enables an 1 pL-level droplet to be ejected and is capable of forcing liquid droplets of greater than 1 pL-level by appropriate pressure in the purging or priming so that the ink can be transported smoothly.

As a practical example of the elliptical nozzle, an elliptical nozzle with its long axis of 8 um and its short axis of 3 um shows that the volume of a droplet is decreased to an average of 10% under the same ejecting conditions, i.e., the same temperature, same voltage, etc., when compared to a circular nozzle with a diameter of 10 um.

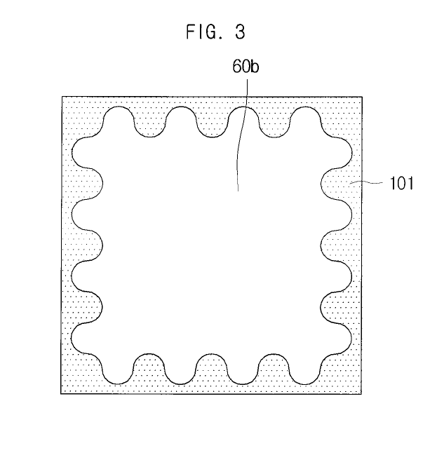

In another embodiment of the present invention, as illustrated in FIG. 3, concavo-convex curves can be successively formed on an inner surface of the nozzle 60. That is, although the cross-section of the nozzle is virtually shaped like a polygon such as a rectangle, the concavo-convex curves can be formed on the inner surface of the nozzle. In this case, like the previously described embodiment, it is also possible to make the actual size of the ink being ejected close to the circle fitted in the inner perimeter of the elliptical nozzle, and thus high resolution print can be obtained.

In case the nozzle simply has a polygonal shape with three or more sides, a stress fracture may easily occur by the stresses from outside forces if one of the sides overlaps with the crystalline direction of the silicon substrate. On the other hand, in the present embodiment in which concavo-convex curves are formed successively in the inner surface of the nozzle 60, no side of the nozzle 60 overlaps with the crystalline direction of the silicon substrate that forms the nozzle plate, reducing the chance of crack by the stress.

If the diameter of a circular nozzle is approximately 12 to 15 um or greater, it is not difficult to prime, purge and eject the ink with a viscosity of about 10 cP. However, if the diameter of the circular nozzle is smaller than 12 to 15 um, the inkjet head with modified nozzle shape according to the present embodiment can have an advantage in ejecting a minute droplet, compared to the circular nozzle with a similar nozzle space. Therefore, in this embodiment, if concavo-convex curves are formed on the inner surface of each side of the nozzle (that is, if each side of the rectangular-shaped nozzle is 10 um or less in length and/or if the elliptical-shaped nozzle is formed with its long axis of 5 um or greater and its short axis 5 um or shorter), its effects can be maximized.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

As such, many embodiments other than those set forth above can be found in the appended claims.

What is claimed is:

1. An inkjet head comprising:
a chamber configured to house ink; and
a nozzle configured to eject the ink housed in the chamber,
wherein the nozzle is elliptical.

2. The inkjet head of claim 1, further comprising a piezoelectric body configured to provide pressure to the chamber.

3. The inkjet head of claim 1, wherein the elliptical nozzle has a short axis of 5 um or less and a long axis of 5 um or greater.

4. An inkjet head comprising:
a chamber configured to house ink; and
a nozzle configured to eject the ink housed in the chamber,
wherein concavo-convex curves are successively formed on an inner surface of the nozzle.

5. The inkjet head of claim 4, further comprising a piezoelectric body configured to provide pressure to the chamber.

6. The inkjet head of claim 4, wherein a cross-section of the nozzle is virtually rectangular, and each side of the nozzle is 10 um or less in length.
